(19) United States
(12) Patent Application Publication
(10) Pub. No.: US 2010/0026633 A1
(43) Pub. Date: Feb. 4, 2010

(54) REUSABLE ELECTRONIC WRITING AND DISPLAYING DEVICE

(75) Inventors: Jean-Marie Baumlin, Auzin Saint Aubin (FR); Jerome Emonot, Nancy (FR); Eric-Louis Fallet, Varennes Le Grande (FR); Thierry Prigent, Sainte Helene (FR)

Correspondence Address: Akin Gump LLP - Silicon Valley, 3000 El Camino Real, Two Palo Alto Square, Suite 400, Palo Alto, CA, 94306, US

(73) Assignee: INDUSTRIAL TECHNOLOGY RESEARCH INSTITUTE, Chutung, Hsinchu (TW)

(21) Appl. No.: 11/914,129

(22) PCT Filed: Apr. 21, 2006
(86) PCT No.: PCT/EP06/03669

§ 371 Date: Sep. 22, 2009

(30) Foreign Application Priority Data
May 9, 2005 (FR) 0504609

(51) Int. Cl. G06F 3/041

(52) U.S. Cl. 345/173

(57) ABSTRACT

Examples consistent with the invention include a reusable device for writing, displaying and deleting information with an electronic device on a support device having bistable liquid crystals. The reusable device includes a substrate onto which are successively applied and from the substrate: an electricity conducting coating; an optical coating that can absorb all or part of the surrounding light; a coating of a transparent substance in which a plurality of bistable liquid crystals are emulsioned; at least one electricity conducting element being electrically connected to the electricity conducting coating via an electrical voltage generator to form an electric circuit. The electricity conducting element may be in contact and be moved over the surface of the transparent coating in which a plurality of bistable liquid crystals are emulsioned, to produce a modification of the state of light transmission in said transparent coating at the contact, so as to generate the writing and displaying of information, or the deleting of the displayed information.

This application is a national phase application of International Application No. PCT/EP2006/003669, international filing date Apr. 21, 2006, which claims priority to French Patent Application No. 0504609, filed May 9, 2005. These priority applications are hereby incorporated by reference in their entirety.

The invention is in the technical field of displaying with a screen comprising liquid crystals. The invention more particularly relates to a reusable device for writing, displaying and deleting information with an electronic means on a support means comprising bistable liquid crystals.

### BACKGROUND OF THE INVENTION

Electronic means for writing and deleting on flexible supports of paper or plastic are known in the prior art.

U.S. Patent Application 2004/0041799 discloses means comprising an electronic pencil to write or delete on a reusable surface. The surface comprises a coating of bistable dyes that change states by the application of an electric field in a direction practically perpendicular to the surface. When the field is applied in one direction, one can write on the surface, and when the field is applied in the opposite direction, one can erase what has been written. The direction of the field determines the state of the dye. Generally, the two states of the dye are differentiated by the human eye. The end used to delete, or the tip of the electronic pencil used to write, consist respectively of a central electrode and a pair of cylindrical electrodes concentric with the central electrode. This electrode geometry is relatively complex to produce and thus expensive. The electrodes have pointed shapes to produce a high electric field. These shapes have the disadvantage of risking scratching the surface, if the electrode comes into contact with it, and so damaging the coating of bistable dye. Without contact, the distance between the pair of electrodes and the surface must be constant to maintain an electric field of the same level, to change the state of the dye. Keeping the distance constant during movement of the electrodes is difficult to achieve, unless expensive equipment is used. It is necessary to direct the field by complying with the conditions described above (especially: direction practically perpendicular to the surface) to change the state of the dye. It is necessary to increase the value of the electric field (voltage) to increase the width of the writing lines. To increase the value of the electric field, a commonly used means is a potentiometer. The addition of a potentiometer has the disadvantage of increasing both the cost and dimensions of the device. The device, which is equipped for example with an electric battery, has the disadvantage of being an electrical energy consumer, because the applied electric field must be maintained during the activation of the device, for example during the whole the writing stage.

U.S. Pat. No. 5,956,113 discloses a bistable reflecting screen comprising particles of silica clustered in liquid crystals. The concentration of the silica particles is selected so that the screen's reflection or transparency states are maintained after the electric fields, applied between the screen's conductive coatings and causing these changes of screen state, are deleted or canceled. By superimposing different screens and subjecting them to appropriate electric fields, a color image can be formed, based on the incident light rays. These multi-coating screens, based on polymer and liquid crystals, are used for example in imaging systems. These multi-coating screens are relatively complex, thus rather expensive, and not very easy to use in a portability context, because of their thickness mainly due to the multi-coating structure.

To be able to write, display (to use it as memory or memo-board) and delete information on a portable type support, for example on a card, it is desirable to use writing and displaying devices that are both not cumbersome, to be easily portable, and not expensive, in terms of the structure or composition of the device and its operating cost (e.g. consumption of electric batteries). It is desirable that the element used to write on the support does not scratch the surface of this support. In addition, it is desirable that these devices are easy to use, i.e. enable information to be written and deleted easily and quickly.

### SUMMARY OF THE INVENTION

Examples consistent with the invention propose a reusable displaying device, on which information can be written, displayed and deleted. Some examples may overcome the disadvantages or problems of the prior art. Examples consistent with the invention also may provide a device that has no particular constraint, especially not having the constraint of a specific orientation of the means used for writing in relation to the information support, or not having the constraint of an electric field value to be maintained during the device's activation.

In examples consistent with the invention, the assembly constituted by the element for writing and the writing and information support is not cumbersome, thus portable, and not very expensive. They may reduce manufacturing and operating costs, and reusable display support.

According to a first embodiment, a reusable device for writing and displaying information comprises a substrate onto which are successively applied and from the substrate: an electricity conducting coating; an optical coating that can absorb uniformly on all its exposed surface for example all or part of the surrounding light; a coating of a transparent substance in which a plurality of bistable liquid crystals are emulsioned; at least one electricity conducting element, characterized in that the electricity conducting element is electrically connected to the electricity conducting coating via an electrical voltage generator to form an electric circuit, and in that the electricity conducting element is put into contact and can be moved over the surface of the transparent coating, in which a plurality of bistable liquid crystals are emulsioned, to produce a modification of the state of light transmission in said transparent coating at the contact, so as to generate either the writing and displaying of information, or the deleting of this previously displayed information.

According to a variant of the first embodiment described above, the coating of a transparent substance in which a plurality of bistable liquid crystals are emulsioned and the optical coating which can absorb the light are reversed, as regards the order of application of the coatings of the first embodiment described above.

In another variant of the first embodiment described above, the electricity conducting coating and the optical coating which can absorb the light are reversed.

In a particular embodiment, a device such as that described above (according to the first embodiment and both variants), may also comprise a protective coating transparent to light affixed to all the coatings applied to the substrate, to protect them from contacts or scratches.

The device is such that the modification of the state of light transmission in the transparent coating, in which a plurality of bistable liquid crystals are emulsioned so as to generate the writing and displaying of information, is performed by a first voltage pulse transmitted in the electric circuit, when the electricity conducting element is put into contact to close the electric circuit with the transparent coating comprising the plurality of bistable liquid crystal. The first voltage pulse is performed according to an increase followed by a decrease, whose amplitude may have a value of 60 volts.

In another embodiment of the invention, the device is such that the modification of the state of light transmission in the transparent coating, in which a plurality of bistable liquid crystals are emulsioned, is performed by a voltage transmitted to the electric circuit to create a potential difference between the tip of the electricity conducting element and the conducting coating, so as to generate the writing and displaying of information. This voltage can be direct or alternating current. For example a voltage of 60 volts may be applied.

In a similar way, the modification of the state of light transmission in the transparent coating, in which a plurality of bistable liquid crystals are emulsioned so as to delete the writing and displaying of information, is performed by a second voltage pulse transmitted in the electric circuit, when the electricity conducting element is put into contact to close the electric circuit with the transparent coating comprising the plurality of bistable liquid crystals. The second voltage pulse is performed according to a voltage increase followed by a decrease, advantageously with an amplitude of 100 volts.

In a first advantageous embodiment, the optical coating to absorb all or part of the light and the electricity conducting coating form one and the same electricity conducting and light absorbing coating.

In a second advantageous embodiment, the substrate and the optical coating to absorb all or part of the light form a substrate that absorbs light.

In a third advantageous embodiment, the substrate, the optical coating to absorb all or part of the light, and the electricity conducting coating form one and the same electricity conducting and light absorbing substrate.

The electricity conducting element of the device is an electrode having the shape of a pencil with a tip used as contact. The tip used as contact is electricity conducting and deformable, to ensure close contact with the coating with which it is put in contact. The tip of the conducting element may have a shape based on or related to the information which will be produced. That is, in particular, related to the nature (letters, drawings) and line width of the generated writing. The device can also comprise a plurality of electricity conducting elements.

The substrate may be a flexible support, like for example a sheet of paper or plastic. But the substrate can also be a metal support having low surface resistivity, i.e. less than 10 ohms.

Examples of the proposed device can be used with a magnetic plastic card, a smart card, or a loyalty card. In this case, the substrate constitutes all or part of the card surface.

Examples of the proposed device can also be used in a printer. In this case, the substrate is a flexible sheet having a size suitable for use in the printer planned to print said sheet.

Other characteristics and advantages of the invention will appear on reading the following description, with reference to the various figures.

### BRIEF DESCRIPTION OF THE DRAWINGS

FIG. 1 represents a first embodiment of the device according to the invention.

FIG. 2 represents a second embodiment of the device according to the invention.

FIG. 3 represents a third embodiment of the device according to the invention.

FIG. 4 represents a variant of the first embodiment of the device according to the invention represented in FIG. 1.

FIG. 5 represents another variant of the first embodiment of the device according to the invention represented in FIG. 1.

FIG. 6 represents the appearance of the voltage curve, as a function of time, to change the state of a displaying support according to the invention.

### DETAILED DESCRIPTION OF THE INVENTION

The following description is a detailed description of the main embodiments of the invention, with reference to the drawings, in which the same numerical references identify the same elements in each of the different figures.

Bistable liquid crystals, and “cholesteric” bistable liquid crystals, are known in the prior art. These bistable liquid crystals, many of them cholesteric, are used to implement the invention device. Bistable liquid crystals have the advantage of not consuming any energy permanently, for example electric, to maintain them in a stable state. Bistable liquid crystals are frequently used in the technical field of displaying with screens or display supports that integrate these bistable liquid crystals. U.S. Pat. No. 6,637,650 describes a display element comprising a material containing bistable liquid crystals dispersed in a polymer. This material is called PDLC (Polymer Dispersed Liquid Crystals), and generally has a thin coating format. In one example, a coating of PDChLC can be used (Polymer Dispersed Cholesteric Liquid Crystals). The thin coating in PDLC or PDChLC is advantageously made by emulsioning bistable liquid crystals as globules in a polymer. The thin coating thus formed advantageously has flexible solid format. This thin coating is reactive with the application of an electric field, for example to display information. The thin coating has two optical states: One “transmissive” state (good transmissibility), and one “reflective” state (reflecting) and diffusing. These states are both obtained by giving an orientation to the liquid crystals, under the effect of an electric field impulse; then, both optical states remain stable, i.e. can be respectively maintained in the absence of an electric field. This has the advantage, over time, of saving electrical energy, because only occasional impulses are necessary to operate the material's changes of optical state.

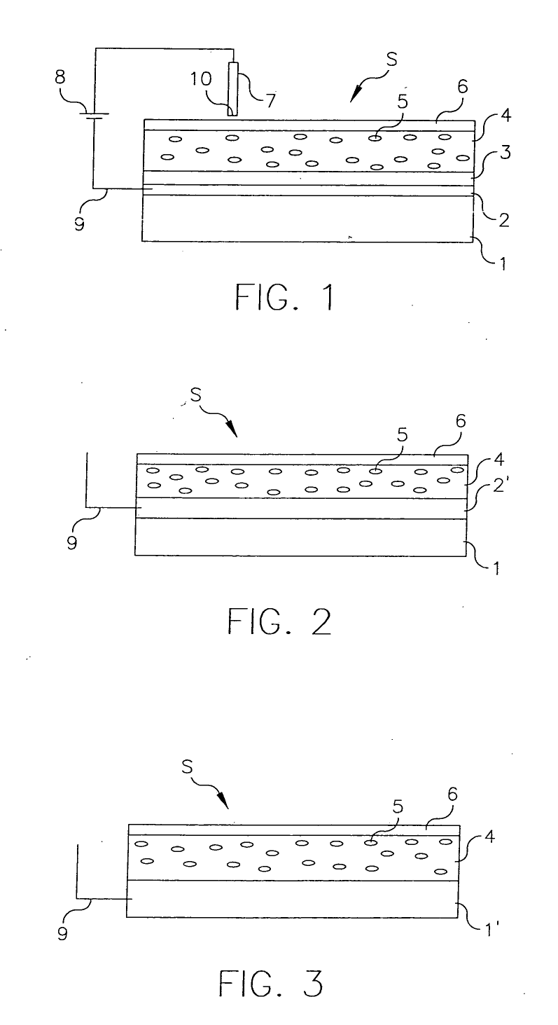

FIG. 1 represents a first embodiment of the invention device. The invention device comprises a support S that enables information to be written, displayed, and deleted on this support. For a base the support S has a substrate 1. The substrate 1 may be flexible. The substrate 1 is, for example, a sheet of paper. The substrate can also be a flexible support, like for example a sheet of plastic, such as a plastic polyester film. From this substrate 1, successively applied to the substrate 1 are an electricity conducting coating 2; an optical coating 3, capable of absorbing uniformly on all its exposed surface all or part of the surrounding light; a coating of a transparent substance 4 in which a plurality of bistable liquid crystals 5 are emulsioned; and a top protective coating 6, transparent to light. The optical coating 3 can absorb all the light, or only absorb part of the light, reflecting the rest, like, for example, a colored coating does. The transparent substance 4 is, for example, a tanned gelatin. The tanned gelatin advantageously resists scratches or aggression by mechanical contacts. This transparent substance 4 also has to favor mechanical contact with an electrode; i.e. it has to have a friction coefficient so that an electrode can slide easily and closely in contact with it. The protective coating 6 is intended to protect the transparent coating 4 in which a plurality of bistable liquid crystals are emulsioned from contacts or scratches. The optical coating 3 may be a coating formed by black or colored nanopigments, with a material like for example carbon black or a dye which is mixed with a polymer. The electrical resistance of the optical coating 3 is high, i.e. higher than or equal to 10 ohms. The transparent coating 4, in which a plurality of bistable liquid crystals 5 are emulsioned in globular form, is for example a PDChLC coating.

The device also comprises an electricity conducting element 7. The electricity conducting element 7 is electrically connected to the electricity conducting coating 2 via an electrical voltage generator 8 to form an electric circuit 9. The electric circuit 9 is produced for example with a wire connection. The connection of the electric circuit 9 with the conducting coating 2 is advantageously a removable connection, which can be disconnected from the conducting coating 2; e.g. a simple connection with a grip attached to the thickness of the support S, and a pin solid with the grip, which is positioned in contact with the conducting coating 2, along the thickness of the latter. The conducting coating 2 is advantageously constituted by an electricity conducting ink, based on metal particles of silver or carbon. The conducting coating 2 can also be transparent and constituted by an ITO type substance (Indium Tin Oxide), that is constituted by a material based on indium and tin oxide.

The conducting element 7 is intended to be put into contact with and move freely on the surface of the protective coating 6, to produce, at the contact, a modification of the light transmission state of the transparent coating 4 in which a plurality of bistable liquid crystals are emulsioned, so as to generate writing, for example with a point or line, and then the display of this writing. This means that the protective coating 6 is either constituted by a dielectric material (not conducting), and or fine enough so that the electric contact is established without disturbance between a tip 10 (electricity conducting) of the conducting element 7 which acts as electrode, and the transparent coating 4 in which a plurality of bistable liquid crystals are emulsioned. The tip 10 has, for example, the shape of a rounded pencil point, or, for example, the shape of a small flat disc, i.e. a few tenths of millimeters to a few millimeters in diameter. The protective coating 6 has a thickness between 0.3 and 3 micrometers. The protective coating 6 has good surface resistivity, i.e. higher than 10⁶ ohms. To limit the voltage required to establish the electric field that enables the change of state of the liquid crystals to be produced, volume conductivity of the protective coating is desirable; which may be why a protective coating 6 is selected whose surface resistivity is between 10⁶ and 10⁹ ohms.

In another simplified embodiment (not represented), the conductive element 7 is put into contact with the transparent coating 4 in which a plurality of bistable liquid crystals 5 are emulsioned, to produce at the contact a modification of the light transmission state of the transparent coating 4 in which a plurality of bistable liquid crystals are emulsioned, so as to generate the writing and displaying of information, or the deleting of the information displayed. In this simplified embodiment, the writing and displaying support S does not include the protective coating 6.

In an embodiment, the electrical voltage generator 8 is incorporated into the electricity conducting element 7. The electricity conducting element 7 advantageously has the shape and dimensions of a pencil or pen, to be able to be easily held in the hand. The electricity conducting element 7 is advantageously equipped with a deformable contact tip 10, to ensure close contact with the coating with which it is put into contact. The electrode 7 is, for example, comprised of silicon filled with carbon particles, and its tip 10 has a hardness of 70 Shore A. The electricity conducting element 7 can be moved by contacting the surface of the top coating of the support S, to produce and display information.

But, in another embodiment, a plurality of electricity conducting elements 7 can be used. These elements 7 can, for example, be incorporated into equipment such as a printer, and their movement can be automatically controlled, for example, using a printer control unit.

The tip of the conducting element has a shape related to the information that is to be produced. The electricity conducting element 7 can be moved and make contact with the surface of the coating, to produce and display this information in the required place on the surface.

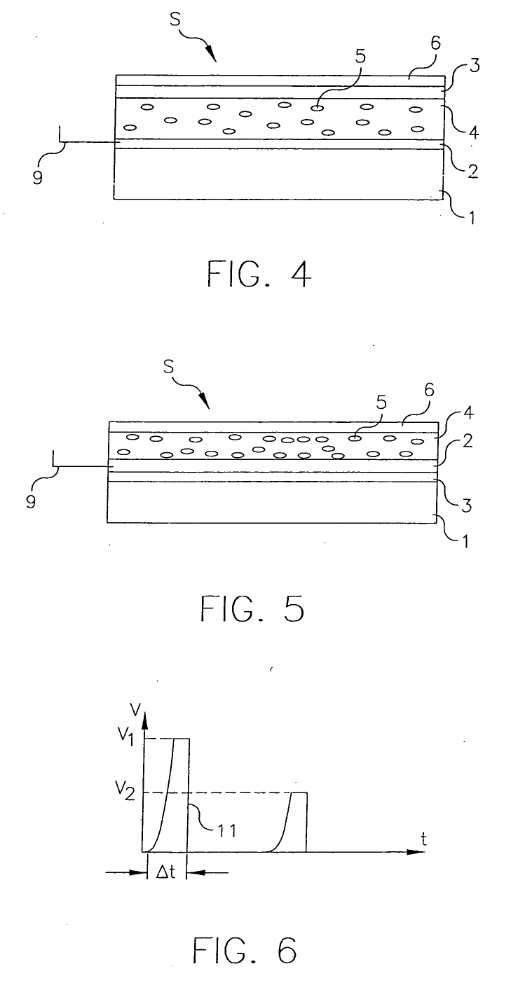

FIG. 4 represents a variant of the embodiment of the device according to the invention represented in FIG. 1 (first embodiment). Compared with the first embodiment of FIG. 1, the optical coating 3, to absorb all or part of the surrounding light, and the transparent coating 4, in which a plurality of bistable liquid crystals 5 are emulsioned, are reversed, as shown in FIG. 4. In this embodiment the electricity conducting coating 2 is transparent. The information produced will be visible through the support S, the substrate 1 being transparent, in this case.

FIG. 5 represents another variant of the embodiment of the device according to the invention represented in FIG. 1. Compared with the first embodiment of FIG. 1, the optical coating 3 to absorb all or part of the light and the electricity conducting coating 2 are reversed: see FIG. 5.

FIG. 2 represents a second embodiment of the device according to the invention. The optical coating to absorb all or part of the surrounding light and the electricity conducting coating form one and the same electricity conducting and light absorbing coating 2′.

FIG. 3 represents a third embodiment of the device according to the invention. The substrate, the optical coating to absorb all or part of the surrounding light and the electricity conducting coating form the same substrate 1′. The substrate 1′ is electricity conducting and light absorbing.

Modification of the state of light transmission in the transparent coating, in which a plurality of bistable liquid crystals are emulsioned so as to generate the writing and displaying of information, is performed by a first voltage pulse transmitted in the electric circuit, when the conducting element 7 is put into contact, using the tip 10, to close the electric circuit with the emulsioned coating comprising the plurality of bistable liquid crystals.

Modification of the state of light transmission in the transparent coating, in which a plurality of bistable liquid crystals are emulsioned so as to delete the writing and displaying of information, is performed by a second voltage pulse transmitted in the electric circuit, when the conducting element is put into contact to close the electric circuit with the emulsioned coating comprising the plurality of bistable liquid crystals.

According to FIG. 6, to write and delete, the electrical voltage pulse is given, for example, according to a sequence that is represented by a curve 11. Curve 11 represents the value of the electrical voltage pulses V as a function of time t. These voltage pulses, corresponding for example to the values v₁ and v₂, are given during a time interval Δt. The value of Δt is selected from one of the values 10, 50, or 100 milliseconds respectively. The voltage pulses are controlled, for example, using a two-position button placed on an outside surface of the conducting element 7. To write on the support S, the value of the voltage pulse corresponds to an increase followed by an instantaneous drop, according to a sharp front, as represented by curve 11, with voltage value v₂ to zero; v₂ is between 40 volts and 80 volts. To delete on the support S, the value of the voltage pulse corresponds to an increase followed by an instantaneous drop, according to a sharp front, as represented by curve 11, with voltage value v₁ to zero; v₁ is between 80 volts and 120 volts; v₁ (to delete) is generally higher than v₂ (to write). Advantageously, the power supply used is direct current. But, an alternating current power supply can also be used. The voltage and duration values of the electric pulses are given as examples, because these depend on the type of liquid crystals used, on the way they are mixed in the polymer, and on the thickness of coatings deposited on the substrate. Furthermore, there is a relation between the value of the applied voltage, and the level of optical density seen during the display. Thus, a plurality of densities can be displayed, by making the voltage value vary according to the location of the tip of the electrode on the support S: this enables information to be obtained as an image. Consequently, other voltage and duration values of the electric pulses can be used in the invention device.

The invention device can also advantageously be used with a card. Then the display can deliver visual information that can be modified over time. The display can advantageously replace a magnetic strip that codes information, by making this information visual. The card can be provided with an electronic memory. Smart cards are widely used and cover different needs: banking, telephone, transport, etc. Generally, information, like for example alphanumeric codes identifying a person or corresponding to a particular service, is displayed on the smart card. But, the smart card user can also need to display information on the card itself momentarily. The information to be temporarily displayed is for example the calculated result of an operation related to a bank account, a telephone number, a due date, or any other information related or not to the smart card. The displayed information can thus deliver, for example, information written in the card's memory. Therefore, the information writing and displaying support S can easily be incorporated in a window of the card. The writing and displaying support must be produced in a material compatible with that of the card. The support is incorporated in the card, for example, by gluing the writing and displaying support onto the card, or by a clamping, or even pressing, and/or possibly welding adjustment in an opening made in the card. The writing and displaying support 1, 1′ is, for example, made of polyethylene terephthalate, and 0.175 millimeters thick. Another variant is to use a metal writing and displaying support having low surface resistivity, less than 10 ohms. The window can have, for example, a rectangular shaped surface area of a few square centimeters, placed in the card's available blank surface. The surface can also, for example, correspond to the whole surface area of the card, which is generally equal to several dozen square centimeters.

While the invention and its applications have been described with reference in particular to its embodiments, it is apparent that variants and modifications can be produced within the scope of the claims.

What is claimed is:

1. Reusable device for writing and displaying information, comprising a substrate over which are successively applied an electricity conducting coating;
an optical coating that can absorb all or part of the surrounding light;
a coating of a transparent substance in which a plurality of bistable liquid crystals are emulsioned;
at least one electricity conducting element being electrically connected to the electricity conducting coating via an electrical voltage generator to form an electric circuit, each at least one electricity conducting element being put into contact and can be moved over the surface of the transparent coating, in which a plurality of bistable liquid crystals are emulsioned, to produce a modification of the state of light transmission in the transparent coating at the contact, so as to generate the writing and displaying of information.

2. The device according to claim 1 characterized in that the electricity conducting element is put into contact and can be moved on the surface of the transparent coating in which a plurality of bistable liquid crystals are emulsioned, to produce a modification of the state of light transmission in said transparent coating at the contact, so as to generate the deleting of the information displayed.

3. The device according to claim 1, characterized in that the coating of transparent substance in which a plurality of bistable liquid crystals are emulsioned and the optical coating are reversed.

4. The device according to claim 1, wherein the electricity conducting coating and the optical coating are reversed.

5. The device according to claim 4, characterized in that the substrate and the optical coating to absorb all or part of the light form a substrate that absorbs light.

6. The device according to claim 1, wherein the optical coating to absorb all or part of the light and the electricity conducting coating form one and the same electricity conducting and light absorbing coating.

7. The device according to claim 1, wherein the substrate and the optical coating are configured to absorb all or part of the light, and the electricity conducting coating forms one electricity conducting and light absorbing substrate.

8. The device according to claim 1, further comprising a light transparent protective coating deposited over the device to protect the other coatings from contacts or scratches.

9. The device according to claim 8, wherein the protective coating has a thickness between about 0.3 and 3 micrometers.

10. The device according to claim 9, wherein the protective coating has surface electrical resistivity higher than about 10⁶ ohms.

11. The device according to claim 1, in which the modification of the state of light transmission in the transparent coating, in which a plurality of bistable liquid crystals are emulsioned, is performed by a first voltage pulse transmitted in the electric circuit, when the electricity conducting element (7) is put into contact to close the electric circuit with the transparent coating comprising the plurality of bistable liquid crystals to generate the writing and displaying of information.

12. The device according to claim 11, wherein the first voltage pulse is performed according to an increase followed by a decrease of the first voltage pulse with an amplitude between about 40 and 80 volts.

13. The device according to claim 1, in which the modification of the state of light transmission in the transparent coating, in which a plurality of bistable liquid crystals are emulsioned, is performed by a direct or alternating current voltage transmitted in the electric circuit, when the electricity conducting element is put into contact to close the electric circuit with the transparent coating comprising the plurality of bistable liquid crystals to generate the writing and displaying of information.

14. The device according to claim 2, in which the modification of the state of light transmission in the transparent coating, in which a plurality of bistable liquid crystals are emulsioned, is performed by a second voltage pulse transmitted in the electric circuit, when the electricity conducting element (7) is put into contact to close the electric circuit with the transparent coating comprising the plurality of bistable liquid crystals to delete the writing and displaying of information.

15. The device according to claim 14, wherein the second voltage pulse is performed according to an increase followed by a decrease of voltage with an amplitude between about 80 and 120 volts.

16. The device according to claim 1, comprising at least one electricity conducting element having a contact tip.

17. The device according to claim 16, characterized in that the contact tip has the shape of a rounded pencil point or flat disc.

18. The device according to claim 16, wherein the contact tip is electricity conducting and deformable to ensure close contact with the coating with which it is put in contact to be moved.

19. The device according to claim 1, wherein the substrate comprises one of a flexible support and a metal support having surface electrical resistitivity less than 10 ohms.

20. (canceled)

21. The device according to claim 1, wherein the substrate comprises one of a portion of a surface of a card and a flexible sheet having a size suited to be used with a printer.

22. (canceled)
